(19) United States
(12) Patent Application Publication
(10) Pub. No.: US 2014/0379584 A1
(43) Pub. Date: Dec. 25, 2014

(54) ANTI-FRAUD FINANCIAL TRANSACTION METHOD

(71) Applicant: FraudFree Finance, LLC, San Diego, CA (US)

(72) Inventor: Erik Ward, San Diego, CA (US)

(21) Appl. No.: 13/927,102

(22) Filed: Jun. 25, 2013

(51) Int. Cl. G06Q 20/38

(52) U.S. Cl. CPC G06Q 20/3829
USPC 705/71

(57) ABSTRACT

An anti-fraud financial method that enables a strong initial registration process for registering a financial payment instrument such as a credit card, debit card, money transfer, or checking account with a financial institution without external storage of private keys, so that only the registrant has the private key, and enables a strong financial transaction authentication and authorization process that is verifiable in real-time before the financial transaction is complete, that is computationally difficult to forge, cannot be replayed or otherwise altered after the financial transaction, and is backward compatible with existing financial transaction processing systems.

### BACKGROUND OF THE INVENTION

1. Field of the Invention

One or more embodiments of the invention are related to the field of data processing systems and communication systems. More particularly, but not by way of limitation, one or more embodiments of the invention enable an anti-fraud financial method that enables a strong initial registration process for registering a financial payment instrument such as a credit card, debit card, money transfer, or checking account with a financial institution without external storage of private keys, so that only the registrant has the private key, and enables a strong financial transaction authentication and authorization process that is verifiable in real-time before the financial transaction is complete, that is computationally difficult to forge, cannot be replayed or otherwise altered after the financial transaction, and is backward compatible with existing financial transaction processing systems.

2. Description of the Related Art

Financial fraud in the United States is a multi-billion dollar problem. The insecurity of the current credit card and debit card system is a major contributor to this epidemic. Both registering for new cards and the actual financial transaction process at the point of sale are susceptible to fraudulent activity. The present registration process employed by financial institutions lacks methods of high-probability proof of identity of the registering customers, which leads to fraudulent card registration. The present financial transaction process at the point of sale using credit cards or debit cards is riddled with even more insecurity. Using a handwritten signature as the authorization mechanism to approve a transaction presents a multitude of problems. For example, a handwritten signature is easy to forge, easy to replay as a new and separate transaction, can only be verified after the fraud has occurred, and is costly to verify. Additionally, authorized transactions can be easily modified after the actual authorization by editing the invoice, bill, or receipt, as the signature is not unique to the specific transaction for which it was originally generated. Current proposed methods and solutions have not been implemented by financial institutions for three main reasons: the proposed methods do not truly solve these issues; or, the proposed methods are extremely costly and would thus necessitate infeasible overhauls of the financial institutions' infrastructures; or, the methods require either simultaneous systems to run in parallel or complete turnkey system migrations without any phase-in or on-loading period. Therefore, there exists a need for a strong, cryptographically secure system of performing financial transactions that is backwards compatible with current financial institutions' infrastructure.

Generally, anti-fraud financial systems are common, yet encompass several disadvantages, specifically due to poor registration and insufficient authorization processes outlined above. Signatures, for example, are easy to forge and easy to “replay” as additional transactions, e.g., allow the replay of the authorization for additional transactions. Additionally, statements may also be modified after a document, transaction, bill, etc. has been signed. Given current registration and authorization processes that are typical in the art, it is generally difficult to verify a financial transaction to determine whether fraud has occurred until after the transaction has completed. In general, signatures and user-identities are normally only verified after the fraud has occurred. Additionally, some transactions do not utilize handwritten signatures, such as computer payments or telephone payments and have additional security problems. Other disadvantages of current anti-fraud financial systems revolve around poor registration processes. With a poor registration process, for example, it is costly and time-consuming for a financial institution to determine whether the person registering for a financial instrument, such as a credit card, debit card, check, or any other instrument associated with an account number, possesses the true identity of the claimed potential customer or user.

United States Patent Publication 2012/0254041 to Saxena et al., hereinafter Saxena, entitled “One-Time Credit Card Numbers”, appears to disclose a credit card fraud detection system using various technologies related to one-time credit card numbers originating from a customer device and independently generated from the customer device, supporting both offline and online purchases. Saxena discloses that the one-time credit card number may be generated using a shared secret and the transaction may be signed using a user private key.

The drawbacks of using the system of Saxena is that the disclosure appears to only relate to credit cards, appears to lack technology that is backwards compatible with financial institutions' current credit card systems, appears to lack a disclosure of a registration process, and appears to require a shared secret. For example, the system of Saxena appears to discuss standard public key cryptography digital signatures, however specifically refers to multiple credit card numbers being generated using a shared secret, i.e., one-time credit card number per transaction. Using a shared secret provides several disadvantages. Further, the system of Saxena does not support commonly occurring events such as routine payments and is thus not backwards compatible with the present financial transaction system.

Another drawback of the system is that the disclosure appears to lack the necessary technology to enable the system to be backwards compatible with financial institutions' current credit card systems. As such, the system of Saxena would be extremely costly to bring to market and would not operate efficiently within the current credit card industry. Furthermore, the disclosure appears to only discuss credit cards, lacking any mention of other forms of financial payment systems and transactions. Finally, the system appears to lack any mention of a registration process, which lowers the security and integrity of anti-fraud financial systems.

For at least the limitations described above there is a need for an anti-fraud financial method that relates to various forms of financial accounts, is backwards compatible with current financial transaction systems, and includes a secure registration process.

### BRIEF SUMMARY OF THE INVENTION

One or more embodiments described in the specification are related to anti-fraud financial methods and systems that enable a strong initial registration process for registering a financial payment instrument such as a credit card, debit card, money transfer or checking account with a financial institution without the use of shared secrets or external storage of shared secrets or private keys. At least one embodiment of the invention enables a strong financial transaction authentication and authorization process that is verifiable in real-time before the financial transaction is complete, that is computationally difficult to forge, cannot be replayed or otherwise altered after the financial transaction, and is backward compatible with existing financial institution transaction processing systems. Embodiments of the invention also utilize a single financial account number associated with the financial payment instrument, e.g., a single credit card/checking account/other account number, etc., and do not require one-time account numbers, which are generally not backward compatible with existing financial systems. Embodiments of the invention provide the following advantages:
A strong, backwards-compatible registration process and backwards-compatible transactions.
Enables parallel usage with the currently implemented transaction systems.
Enhances security by protecting the private key and enables out of band verification.
Enhances security on common actions within the currently implemented transaction systems such as routine payments, splitting bills, opening tabs, checking out, performing returns or exchanges, holds and deposits, paying on behalf of others, etc.
Enhances security by allowing for automatic auditing of all of a user's transactions.
Enables cashierless checkout and/or peer-to-peer payments.

One or more embodiments of the initial registration process includes accepting a video of a user reading and verbalizing a hash value or any type of checksum value of the digital certificate, comparing a still shot from the video to a trusted picture, e.g., a DMV photo, and comparing other normal factors including mailing address, etc. In one or more embodiments, the registration process is backwards compatible with current financial account registration processes, and enables end users to generate cryptographically strong and locally stored keys, ensuring that no other user or individual has access or knowledge of the generated private keys. In addition, one or more embodiments of the invention provide a secure initial registration process with high assurance that the end user applying through the registration process possesses the true identity disclosed. According to one or more embodiments of the invention, the user may include one or more individual, one or more businesses, one or more companies, or any combination thereof, or any other entity that is applying for or otherwise attempting to register a financial instrument.

For example, in at least one embodiment of the invention, the initial registration process and system includes the steps of a user signing up for a financial account, such as a credit card, and receiving physical and/or electronic notification of the approval of the financial account with the related one or more financial instruments, such as a checking account, savings account, credit card, debit card, etc., wherein the physical and/or electronic notification includes a barcode, QR code, NFC, Bluetooth, or any other internet downloaded communication, enabling the user to conduct secure electronic communication transactions associated with the approved financial account, for example using a computer, a mobile phone, mobile computer or any other one or more communication devices comprising hardware and/or software applications.

In one or more embodiments, the initial registration process and system enables the one or more communication devices or computers to obtain zero or more one-time use registration codes and one or more registration URL's associated with the financial payment instrument. Embodiments may then generate a pseudorandom number locally. For example, a one-time use registration code and registration URL may be obtained from a barcode on printed registration materials, wherein the communication device may transmit the one-time registration code to the registration URL. In at least one embodiment of the invention, the one or more communications devices or computers receive a first random number to use at least part of a seed from the registration computer or other third party service, such as an online database, online server, online or offline institution, website, or other web-based applications. In one or more embodiments, the system and method may include seeding a key generator with the seed before generating the public key and private key.

In at least one embodiment, the one or more communication devices or computers may receive at least one second random number from a registration computer or other third party service, as explained above, and may generate a pseudorandom number. In one or more embodiments, the one or more communication devices or computers may perform a combination function, such as XOR, to combine the first random number, the at least one second random number and the pseudorandom number, and to generate and use at least as part of a seed, wherein the system and method may include seeding a key generator with the seed before generating a public key and private key pair. In one or more embodiments, the system and method may include periodically caching pseudorandom numbers from a registration computer or at least one third party source or service, in order to secure random number generation if any third party source or service, or registration computer is deficient, broken, inaccessible, or lacking the capability to process information and complete a user registration even if one or more software and/or hardware defects occurs.

In at least one embodiment, the initial registration process and system, using the one or more communication devices or computers, may include generating a hash value of the public key using the user computer, prompting the user to say the hash value of the public key, recording video of the user saying the hash value of the public key, or capturing at least one image, and/or audio recording of the user and/or the hash value readout, accepting an agreement of terms of services from the user, and submitting the hash value and video or at least one image of the user to the registration computer at the registration URL

In one or more embodiments, the initial registration process, using a financial account server such as a credit card server or a Certificate Authority server, may also verify that the hash value is equal to the user's read out of the hash value, obtain a trusted picture of the user from a trusted source to ensure the user is of the true identity as claimed, and verify that the user in the video or at least one image matches the trusted picture of the user from the trusted source before generating the cryptographic digital certificate. According to at least one embodiment, the initial registration process may also obtain a picture of the user from the video or at least one image, and insert the picture of the user into the cryptographic digital certificate. This enables a third party to authenticate whether a customer is the same person as the user claims to be.

In at least one embodiment of the invention, if the verification is valid, the financial account server may create and sign a certificate for the user and transmit the signed certificate back to the user, such that the user is then registered with high reliability and with strong cryptographic keys without anyone else knowing, or any other system or memory holding the user's private key or keys.

The anti-fraud financial system and method is backwards compatible with current financial systems. In order to be backwards compatible, the system accepts current financial instruments, such as credit cards, debit cards, check books, money transfers, or any other financial account, without the need for legacy infrastructural changes. In at least one embodiment, the system inserts an account number associated with the financial payment instrument into the cryptographic digital certificate to enable backwards compatibility with existing financial transaction systems. In addition, the system and method may encrypt the account number with a key such that only the financial institution may decrypt it before inserting the account number into the cryptographic digital certificate. The encryption may be performed in one or more embodiments either symmetrically with the Financial Institution's symmetric key or asymmetrically with the Financial Institution's public key. In one or more embodiments, the system and method may obtain the account number, such that the account number is associated with a credit card account, debit card account, checking account, money transfer account, or any combination thereof. As such, when a secure transaction is processed, after the signature has been verified, the financial institution may extract the encrypted financial account information, decrypt the account information, and process the information, as currently done with existing financial transaction systems. This enables current financial account holders, such as credit card holders, to use the financial account in both a secure manner using the anti-fraud financial system and method described herein, and/or with legacy non-digital transactions using existing systems. This also allows merchants to use the anti-fraud financial system and method described herein, and/or their legacy non-digital transaction system.

By way of one or more embodiments of the invention, the system and method include accepting a bill from a merchant computer for the financial transaction, verifying the digitally signed bill, and then digitally signing the financial transaction to create a digitally signed invoice using the user computer and thereby authorizing the transaction. In addition, in at least one embodiment, the system and method may transmit the cryptographic digital certificate and the digitally signed invoice from the user computer to the merchant computer or financial institution computer or both. In one or more embodiments, the system and method may verify a digitally signed invoice of the financial transaction, and verify that the cryptographic digital certificate has not expired and is trusted by the Certificate Authority, or any other financial account server. For example, in at least one embodiment of the invention, the system and method may verify that a picture extracted from the cryptographic digital certificate is the user, for added security and in order to ensure authenticity.

In at least one embodiment, the merchant may forward the transaction details, signature, and certificate to the financial institution. The system and method may extract the account number from the cryptographic digital certificate using the financial institution computer and process the financial transaction associated with the account number with the existing financial transaction systems. For example, the financial institution may verify the transaction signatures, and if valid, proceed to extract the encrypted account information from the cryptographic digital certificate and decrypt it to obtain the unencrypted account information. In one or more embodiments, the one or more embodiments may also include decrypting the account number, such as decrypting a serial number, using a key that is only known by the financial institution, transmitting the authorization to complete the financial transaction to the merchant computer from the financial institution computer if the user has sufficient credit or funds to conduct the financial transaction, and transmitting a signed authorization to the Merchant, where then the Merchant sends a signed receipt to the User computer/device. In at least one embodiment of the invention, the financial institution is the only entity that may decrypt information of the certificate that contains original financial account information, in order to obtain the original financial account information. In one or more embodiments, the account information is not encrypted.

According to one or more embodiments of the invention, the system and method allow a user to scan in a financial transaction, such as using a barcode, QR code, NFC, Bluetooth and/or through the Internet, verify the signature as previously explained, and display the financial transaction details to the user. In one or more embodiments, once the bill is transmitted to the user computer from the merchant computer, the system and method may forward the bill from the user computer to at least one other user computer to enable the at least one other user to contribute to or complete the financial transaction wherein the at least one other user may split the financial transaction according to a percentage or amount or item with or without a tip amount associated with the financial transaction or any combination thereof. In at least one embodiment of the invention, the system and method may accept a tip amount from the user computer to add to the financial transaction, accept a request of the invoice of the financial transaction from the user computer without interaction with a cashier, and then digitally sign the financial transaction. As such, the merchant computer is able to verify the additional amounts added to the financial transaction. In addition, one or more embodiments allow a user to download the cryptographically secure receipts of the one or more financial transactions.

In at least one embodiment of the invention, the anti-fraud financial system and method of processing financial transactions, as discussed herein, may also process financial transactions in a reverse manner, such as a merchant, cashier, or other source of sales representative transmitting the financial transaction to the user, allowing the user to sign the financial transaction and transmit the signed financial transaction to a financial institution, allowing the financial institution to also sign the financial transaction and transmit the financial institution signed financial transaction back to the user, allowing the user to transmit the user signed and financial institution signed financial transaction to the merchant, cashier, or other source of sales representative, and allowing the merchant, cashier, or other source of sales representative to transmit a receipt to the user. In at least one embodiment of the invention, each signature is verified before transmission.

In addition to or alternatively, one or more embodiments of the invention enable the merchant, cashier, or other source of sales representative to transmit a financial transaction to the user, allow the user to sign the financial transaction and transmit the signed financial transaction to a financial institution, allow the financial institution to also sign the financial transaction and transmit the financial institution signed financial transaction to the merchant, cashier, or other source of sales representative, and allow the merchant, cashier, or other source of sales representative to transmit a receipt to the user. In at least one embodiment of the invention, each signature is verified before transmission.

In one or more embodiments of the invention, a user is able to split the financial transaction by selecting and processing only specific financial transaction items listed on the financial transaction that he/she wishes to pay for, such as splitting individual items from the transaction, selecting specific dollar amounts from the total dollar amount, selecting percentages of the bill, or any combination thereof. Such splitting, according to at least one embodiment, may be processed without a merchant representative having to process bills or process multiple different financial transactions. In one or more embodiments, once one or more listed items of the financial transaction has/have been authorized or paid, the merchant may transmit a cryptographically signed receipt to the user and/or to the financial institution. As such, the user may receive the cryptographically signed receipt and may download and/or relay the receipt to one or more communication devices or computers, such as via e-mail, text message, Bluetooth and/or Internet databases and servers, for future reference and/or auditing against existing statements.

In at least one embodiment, the system and method may display an advertisement, coupon or discount to the user, and/or display information associated with at least one previous transaction.

The one or more embodiments may display information associated with at least one previous financial transaction that is associated with the account number but which is potentially fraudulent (e.g. unsigned transactions, invalidly signed transactions, signed but unknown to the device, etc.). In at least one embodiment, such auditing of financial statements may occur automatically. As such, the user may view the statements from one or more accounts, for example, and determine whether one or more unsecure transactions are found, alerting the user of fraudulent transactions. In one or more embodiments, in order for automatic auditing of financial transaction statements and financial transaction receipts to occur, the user may link his/her financial accounts to one or more online account portals associated with the one or more financial institutions linked to the one or more user financial accounts. As such, the one or more account portals are able to compare every financial transaction generated by the one or more financial accounts and authorized by the user's one or more computers or communication devices. This allows for automatic and real-time audit, fraud detection and prevention, allowing the one or more online portals, financial institutions, or user's one or more computers or communication devices to locate the source of the fraud (e.g. a stolen private key, stolen financial account, etc.

In one or more embodiments, the system and method may include accepting from the user a temporal limit or range, spending maximum, category of financial transaction, recurring time of payment, list of users who can charge to a tab, a tab closeout command, secure return request, or any combination thereof to limit the financial transaction. As such, for example, the user may open secure tabs, such as bar tabs, wherein the end dollar value cannot exceed a predefined dollar amount, spending maximum, temporal limit or range, recurring time of payment, list of users who can charge a tab, or a category of a financial transaction. According to one or more embodiments of the invention, in order to avoid over-charges on financial transactions, fraudulent charges on financial transactions on tabs of financial accounts, and/or neglecting to close-out or check-out of an open tab or financial transaction with a merchant, a user may secure a tab with pre-specified attributes, such as a temporal limit or range, spending maximum, category of financial transaction, recurring time of payment, list of users who can charge to a tab, a tab closeout command, secure return request, or any combination thereof. For example, the user may specify a not-to-exceed value for a maximum value of a financial transaction or bill, an expiration date and/or time to avoid the need to manually close-out or check-out of the tab or financial transaction with a merchant, and whether specific people or other users have access to the tab and have the capability to charge to the tab in addition to the user. In at least one embodiment, the user may manually checkout or closeout a tab at any point using his/her user one or more computers and/or one or more communication devices, either by being physically present at the source of the financial transaction and/or remotely. In addition to, or alternatively, in at least one embodiment, the user may re-define, amend, add to, edit, or remove one or more of the pre-defined limits or attributes of the secure tab of financial transactions, such as a temporal limit or range, spending maximum, category of financial transaction, recurring time of payment, list of users who can charge to a tab, a tab closeout command, secure return request, or any combination thereof, either specific to a merchant, cashier, or other source of sales representative or in a non-specific manner, such as a general limit or defined set of limits or attributes associated with the financial account.

In one or more embodiments, the system and method enables a user to automatically checkout, or close the tab non-manually, without the need for a cashier, since the tab on the financial account may automatically close after a temporal limit or range, spending maximum, category of financial transaction and/or recurring time of payment has occurred and/or maximized. In one or more embodiments, checking out, or closing the tab, without the need for a cashier, allows a user to scan the purchased goods, items or services with a user's one or more computers or one or more communication devices, to create a Purchase Order or similar purchase list, or purchase services transaction, and to submit a payment for goods, items and/or services, all without the need for a cashier, merchant, or any other check-out service physically present.

By way of one or more embodiments, a user may open a secure tab directly with a merchant, cashier, or other source of sales representative using the user's one or more computers and/or one or more communication devices. This may prevent fraudulent activity that may be performed by the merchant, cashier, or other source of sales representative, in which the merchant, cashier, or other source of sales representative may not exceed a predefined attribute, as explained above, defined by the user prior or during the opening of the secure tab. In at least one embodiment, the merchant, cashier, or other source of sales representative may charge items, services, or goods in real time, differing from a current or existing process where the merchant, cashier, or other source of sales representative may keep track of sold/charged items and process the charges at a later date or at the end of an exchange. As such, it is not necessary for the user to check-out or close-out a tab in order to process any financial transaction, as the financial transactions may take place in real-time.

According to at least one embodiment of the invention, opening a secure tab by a user directly with a merchant, cashier, or other source of sales representative using the user's one or more computers and/or one or more communication devices, includes identification of the merchant, cashier, or other source of sales representative using a scannable code, barcode, password, key, or any other security protocol, provided by the merchant, cashier, or other source of sales representative, or a selection from a list of local merchants, cashiers, or other source of sales representatives determined using a source of a location finder, such as by GPS location, NFC, general merchant lookup, a map, yellow-pages, Internet or any other computer or communication device application. In at least one embodiment, the user may then verify the merchant, cashier, or other source of sales representative's certificate and signature, and may then optionally set and select pre-defined limits and/or attributes of the secure tab, including but not limited to a maximum dollar threshold allowable on the entire tab, a maximum charge amount allowable per item, service or good charged on general financial transactions, a maximum timespan or specific time (and/or date) when the tab will automatically close, a designation of specific good/services or categories of items allowable on the tab (e.g. only beer, only appetizers, only clothing), and/or a list of authorized individuals who can charge to the tab.

In one or more embodiments of the invention, the one or more user computers or communication devices may alert the user to each charge or financial transaction applied to the tab in real time to limit fraudulent charges, such that the user may close the tab via the user's one or more computers or one or more communication devices at any time and from any location without interaction from the merchant, cashier, or other source of sales representative. Moreover, in at least one embodiment, the user need not necessarily close the tab at all and may keep it open for an indefinite time period, as it is secure. In addition to, or alternatively, in at least one embodiment, the user may re-define, amend, add to, edit, or remove one or more of the pre-defined limits or attributes of the secure tab of financial transactions specific to a merchant, cashier, or other source of sales representative, or in a non-specific manner, such as a general limit or defined set of limits or attributes associated with the financial account.

By way of one or more embodiments of the invention, using an application program interface (API), and using API access to the user's financial account statements and transactions, the API is able to compare financial account statements processed to financial account statements submitted and transmitted from the user and to known payments or payment techniques associated with the user. As such, for example, if financial account statements or transactions were found as unknown to the API, such as a user authorizing a financial transaction using a different source of a financial account, different credit card, different debit card, different check book account, etc., the API is able to notify the user of such transactions for added security. This also allows for monitoring of unsigned transactions, invalidly signed transactions, transactions signed but unknown to the device, etc.

In one or more embodiments, the anti-fraud financial system and method may include an API or any other application and/or the necessary hardware and software technology on one or more computers and/or one or more communication devices for performing the necessary steps required by the method. The technology, in at least one embodiment of the invention, may include a method of password protecting the private key that generates the signature (and other standard security protection methods such as locking out, etc.), the ability to integrate deals/discounts from the merchant or other merchants, cashiers, and sales representatives, the ability to integrate advertisements, the ability to set “admin” permission holders (i.e. parents) to limit usage based on time of day, spending maximums, category of purchasable items, or any other measurable criteria or attribute, and/or the ability to integrate Social Media (e.g. Facebook, Twitter) to determine registration/authentication processes. In addition or alternatively, the technology may include the ability to instantly review comprehensive analysis of spending patterns, the ability to process secure returns/exchanges with merchants, cashiers, or other sales representatives, the ability to set up secure routine payments (e.g. personal recurring utility bills, the rights to sign on behalf of another such as company credit cards, layaway and payment plans, etc.), and/or the ability to automatically audit credit card activity by linking the one or more computers and/or one or more communication devices purchases against the user's financial account(s) to point out any purchases on their ledger not made by the one or more computers and/or one or more communication devices, thus detecting potential fraud in real time. In at least one embodiment, the technology may additionally, or alternatively, include an improved challenge response mechanism used in place of services such as ‘Verified By Visa’, protection against DDoS attacks, the ability to forward the financial transaction of items, goods, or services processed to a third party or another user other than the user at another physical and/or remote location allowing the third party or other user to sign, authorize, or process payments for the one or more financial transaction or one or more items, goods, or services, of the financial transaction, and/or generate a signed proof of credit balance or account balance or available funds or credit score, etc., available by the user.

In at least one embodiment of the invention, the anti-fraud financial system and method may allow for routine payment mechanisms, where a user may establish authorized payment rules for routine payments. As such, the user is able to allow for recurring payments of bills, outstanding accounts, and other financial statements such as bills, accounts and/or statements associated with utilities, gas, electric, cable, Internet, car payments, mortgage, etc.

In one or more embodiments, routine payment mechanisms may encompass paying on behalf of one or more other users or entities. For example, a user or entity, such as a business, enterprise, or corporation, may designate one or more other users or enterprises, and/or one or more other user's device(s) or business device(s) with the authorization to use the user's financial accounts to submit the payment for bills, outstanding accounts, or statements, without the one or more other users or businesses gaining access to the user's primary key(s) and/or the user's financial instruments associated with the financial account(s) such as credit cards, debit cards, checkbooks, money orders, etc.

According to one or more embodiments, the one or more other users or businesses may optionally be restricted to specific usage of the user's routine or recurring payment mechanisms, based on rules and restrictions set by the user. For example, a business company XYZ may authorize the use of its company credit card, or other financial instrument, to Employee #1 for a business dinner with or without restrictions and limitations on date, time, dollar amount, etc. As another example, a user may authorize up to a specific dollar amount on a financial instrument that may be used by one or more other users, or enterprises, as recurring or routine payments, for example including month bills, e.g., at a specific location, such as at school, at work, at a restaurant, at an event, on vacation, etc. Such routine payment mechanisms, in at least one embodiment, may include layaway or payment plans, wherein a user may establish routine payments to a merchant, cashier, other source of sales representative, or entity accepting one or more payments for one or more layaways or payment plans based on the rules and regulations of the one or more of the merchant, cashier, other source of sales representative, or entity accepting one or more payments. The merchant, cashier, other source of sales representative, or entity accepting one or more payments may be automatically informed, notified and/or alerted if the user's one or more financial instruments or financial accounts drop below a certain threshold and/or if the financial account or financial instrument associated with the merchant, cashier, other source of sales representative, or entity accepting one or more payment is altered and/or canceled. Such routine payment mechanisms allow for greater security and allow for all involved and/or associated one or more parties to be informed, notified and alerted, in real time, of the one or more items, goods or services charged, the date and time of the one or more charges, and the dollar amount or percentage of the one or more charges.

By way of one or more embodiments of the invention, the anti-fraud financial system and method may include peer to peer payments, where a user or enterprise may generate their own bill, outstanding balance and/or statement using technology, such as using a user computer or communication device using an application, and for one or more other users to submit payments, and/or transmit payments between one or more other users such as for borrowed cash, reimbursement on purchases, rent payments to landlords, etc. Such peer-to-peer payments are similar to a merchant, cashier, source of sales representative or other entity accepting one or more payments generating a bill, outstanding balance or statement to a user; however with such a process, a user may generate a bill, outstanding balance, or statement to one or more other users. In at least one embodiment, using the peer to peer payment mechanism, a user may directly submit payment for a specific charge of one or more items, goods or services on one or more user's bills, outstanding balances, or statements using the user's own financial instruments and/or financial accounts. Embodiments of the invention do not hold secure details of the other user in peer to peer transactions, which is unknown in the art.

In at least one embodiment of the invention, the anti-fraud financial system and method may include a secure returns mechanism, wherein a merchant, cashier, source of sales representative or other entity accepting one or more payments may review and verify specifics of financial transactions of any previous user purchase using the cryptographically secure digital receipt in order to evaluate the validity of a proposed return exchange transaction on one or more items, goods, or services of the financial transaction. As such, fraudulent returns may be prevented.

In one or more embodiments, the anti-fraud financial system and method may include a preauthorized financial account checks, holds, or deposits mechanism, wherein a merchant, cashier, source of sales representative or other entity accepting one or more payments may place a hold, reservation, and/or deposit against a user's one or more financial accounts or financial instruments prior to the exchange of one or more items, goods, or services. As such, theft and fraud may be limited, and a user's ability to pay a future impending bill is either guaranteed or can be proven to be paid at that particular point in time. For example, preauthorized financial account checks, holds, or deposit mechanisms may relate to hotel incidental charges, automotive repair work quotes, and/or any other one or more goods or services that are provided prior to the complete and/or final financial transaction of the financial payment from a user to a merchant, cashier, source of sales representative or other entity accepting one or more payments. As such, in one or more embodiments, preauthorized financial account checks, holds, or deposits mechanisms may include one or more agreements, promise to pay techniques, and/or other preauthorized forms of payments from a user's one or more financial accounts.

According to at least one embodiment of the invention, the anti-fraud financial system and method may include a user transmitting at least one bill, charge, outstanding balance, or statement, or a portions of at least one bill, charge, outstanding balance, or statement, to one or more other users from the user's one or more computers and/or one or more communication devices, in order to authorize the one or more other users to submit one or more financial payments. During a Financial Transaction Process, in at least one embodiment, the user may select a specific dollar amount, a specific item, and/or a specific percentage to transmit to the one or more other users using the user's one or more computers and/or one or more communication devices to enable real-time authorization of payment by the one or more other users for the user. As such, multiple users, including the user and one or more other users, may submit financial payments for items, goods, or services, or portions of the items, goods, or services, at the point of sale or point of financial transaction, without being physically collocated.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an architectural view of an exemplary system that may implement at least one embodiment of the anti-fraud financial method.

FIG. 2 illustrates a first embodiment of the registration process according to an embodiment of the invention.

FIG. 3 illustrates a second embodiment of the registration process according to an embodiment of the invention.

FIG. 4 illustrates an embodiment of the financial transaction process according to an embodiment of the invention.

FIG. 5 illustrates an embodiment of the payment terms process according to an embodiment of the invention.

FIG. 6 illustrates an embodiment of the intercept process according to an embodiment of the invention.

### DETAILED DESCRIPTION OF THE INVENTION

An anti-fraud financial method and system will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

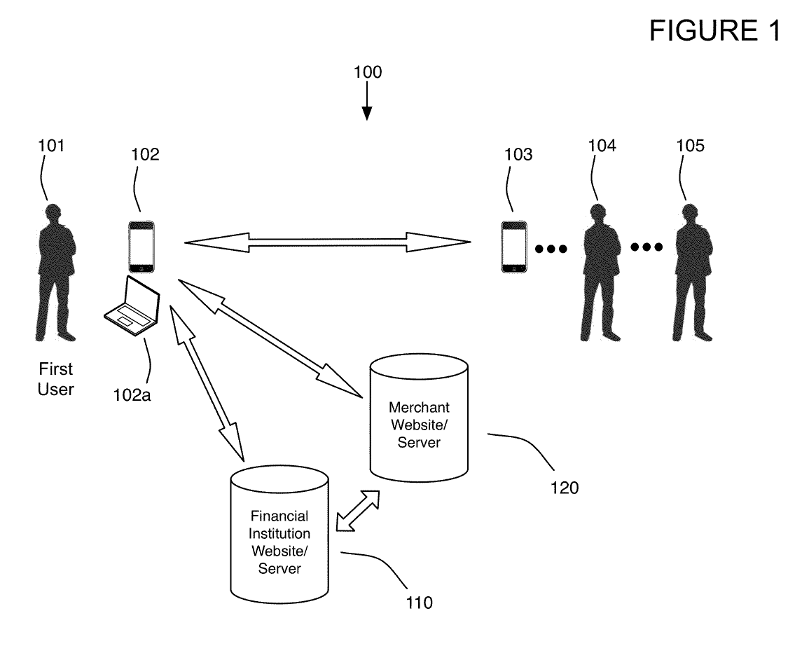

FIG. 1 shows an architectural view of an exemplary system that may implement at least one embodiment of the anti-fraud financial method and system. FIG. 1 depicts an anti-fraud financial method and system 100, a user 101, one or more user computers and/or one or more communication devices 102, 102a, one or more other user computers and/or communication devices 103, and one or more other users 104, 105. As also shown in FIG. 1, the anti-fraud financial method and system includes one or more third party website or server 120 and one or more financial institution website or server 110. In at least one embodiment, one or more third party website or server 120 includes, but is not limited to, one or more merchant website or server, one or more cashier website or server, at least one source sales representative website or server and/or at least one other entity accepting one or more payments' website or server. In one or more embodiments, each of the user 101 and the one or more user computers and/or one or more communication devices 102 are in bidirectional communication with each of one or more other user computers and/or communication devices 103, one or more other users 104, 105, one or more third party website or server 120 and one or more financial institution website or server 110. In at least one embodiment, the one or more third party website or server 120 is in bidirectional communication with the one or more financial institution website or server 110. In one or more embodiments of the system and method, a merchant may be a cashier, source of sales representative, or any other entity accepting any form of payment. In addition, in one or more embodiments of the system and method, a bill may be one or more outstanding balances, one or more charges and/or one or more statements. Furthermore, in one or more embodiments, the user may be one or more users and/or one or more customers.

One or more embodiments of the invention disclose the anti-fraud financial system and method 100 that includes an initial registration process step and a digital signing of a financial transaction step. In at least one embodiment, the initial registration process may include registering a financial payment instrument by generating a public key and private key and storing the public key and private key locally on a user computer 102, 102a. In one or more embodiments, the registering of a financial payment instrument may also include transmitting the public key to a Certificate Authority server and retaining the private key locally, and obtaining a signed cryptographic digital certificate from the Certificate Authority server to complete the registering of the financial payment instrument. In at least one embodiment, the Certificate Authority server may include one or more financial institutions or one or more financial institutions website or server 110.

According to one or more embodiments of the invention, after the initial registration process, the system may include digital signing a financial transaction associated with a user 101 with the private key to initiate the financial transaction with the financial payment instrument. Thus, the system provides secure authentication and authorization to complete the financial transaction from a financial institution computer.

By way of one or more embodiments, the initial registration process may include obtaining a one-time use registration code and registration URL associated with the financial payment instrument using the user computer, and transmitting the one-time use registration code to a registration computer at the registration URL. In at least one embodiment, the initial registration process may further include receiving a first random number to use at least as part of a seed from the registration computer and seeding a key generator with the seed before generating the public key and private key. Alternatively, multiple random numbers, including pseudorandom numbers generated locally, may be utilized in other embodiments.

In at least one embodiment, the initial registration process may include generating a hash value of the public key via the user computer, prompting the user to say the hash value of the public key, recording video of the user saying the hash value of the public key, or capturing at least one image of the user, and/or audio recording the hash value readout, accepting an agreement of terms of services from the user and submitting the hash value and video or at least one image of the user 101 to the registration computer at the registration URL. This may be accomplished for example using mobile computer 102 or personal computer 102a or any other computer capable of obtaining at least one image or video of the user.

In one or more embodiments, during the initial registration process, the system may also verify that the hash value is equal to the user 101 read out of the hash value, obtain a trusted picture of the user 101 from a trusted source, such as the DMV for example, to ensure the user 101 is of the true identity as claimed, and verify that the user 101 in the video or at least one image matches the trusted picture of the user 101 from the trusted source before generating the cryptographic digital certificate.

According to at least one embodiment, the initial registration process may also obtain a picture of the user 101 from the video or at least one image, and insert the picture of the user 101 into the cryptographic digital certificate. This enables a third party to authenticate whether a customer is the same person as the user 101 the customer claims to be.

In one or more embodiments, the initial registration process may include receiving a second random number from a random number generating computer and performing a function to combine the first and second random numbers to create a seed. In one embodiment, servers 110 or 120 may provide random numbers, or any other computer capable of communication with the mobile computer 102 or personal computer 102a, for example a random number generating website accessible over wireless communications, may act as the random number generating computer.

In at least one embodiment of the invention, the initial registration process may include receiving a second random number from the random number generating computer, creating a first pseudorandom number on the user computer, and performing a function to combine the first and second random numbers and the first pseudorandom number to create the seed.

According to one or more embodiments, the anti-fraud financial system and method 100 is backwards compatible with current financial systems, such as hosted on Financial Institution Website/Server 110. In at least one embodiment, the system inserts an account number associated with the financial payment instrument into the cryptographic digital certificate to enable backwards compatibility with existing financial transaction systems. In addition, the system and method may encrypt the accounting number with a key such that only the financial institution may decrypt it before the insertion of the account number into the cryptographic digital certificate. The encryption may be performed in one or more embodiments either symmetrically or asymmetrically with the financial institution's public key. In one or more embodiments, the system and method 100 may obtain the account number, such that the account number is associated with a credit card account, debit card account, checking account, money transfer account, or any combination thereof.

In at least one embodiment, the system and method may display an advertisement, coupon or discount to the user, and/or display information associated with at least one previous transaction.

The one or more embodiments may display information associated with at least one previous financial transaction that is associated with the account number but which is potentially fraudulent (e.g. unsigned transactions, invalidly signed transactions, signed but unknown to the device, etc.). As such, the user 101 may view the statements from one or more accounts, for example, and determine whether one or more unsecure transactions are found, alerting the user of fraudulent transactions. The information provided by the system may be viewed on mobile computer 102 or personal computer 102a or in any other manner in keeping with the spirit of the invention.

In one or more embodiments, the system and method may include accepting from the user 101 a temporal limit or range, spending maximum, category of financial transaction, recurring time of payment, list of users who can charge to a tab, a tab closeout command, secure return request, or any combination thereof to limit the financial transaction. This may be performed by accepting a request from user 104 via mobile computer 103 at computer 102 associated with user 101 for example. In this scenario, user 101 may send an invitation to join a tab via mobile computers 102 and 103, or via the merchant server(s) 120, to user 104 or 105 or both to accept the invitation and be authorized to charge to a tab.

In general, there are multiple entities involved in verification; for example the customer verifies the bill signed by the merchant, the merchant verifies payment authorization signed by the customer, the bank verifies both signatures, the merchant verifies the signed response from the bank, and the customer verifies the signed receipt from the merchant. Embodiments of the invention local to the user may perform local verifications. By way of one or more embodiments of the invention, the system and method include accepting a bill from a merchant computer 120 for the financial transaction, verifying the digitally signed bill, and digitally signing the financial transaction to create a digitally signed invoice using the user computer or communication device 102, 102a. In addition, in at least one embodiment, the system and method may transmit the cryptographic digital certificate and the digitally signed invoice from the user computer or communication device to the merchant computer or financial institution computer or both. In one or more embodiments, the system and method may verify a digitally signed invoice of the financial transaction and verify that the cryptographic digital certificate has not expired and is trusted by the Certificate Authority. Additionally, in at least one embodiment of the invention, the system and method may verify that a picture extracted from the cryptographic digital certificate is the user 101 for added security and in order to ensure authenticity.

In at least one embodiment, the system and method 100 may extract the account number from the cryptographic digital certificate using the financial institution computer and process the financial transaction associated with the account number with the existing financial transaction systems, for example with a layer of software at Financial Institution Website/Server 110 that interacts with the digital information provided by the system. One or more embodiments may also include decrypting the account number using a key that is only known by the financial institution, transmitting the authorization to complete the financial transaction to the merchant computer from the financial institution computer if the user 101 has sufficient credit or funds to conduct the financial transaction, and transmitting a receipt or digitally signed receipt to the user computer or communication device 102 for example.

In one or more embodiments, once the invoice or receipt is transmitted to the user 101 computer or communication devices 102, 102a, and/or one or more other user computers or communication devices 103, from the merchant computer or server 120, the system and method 100 may forward the receipt from the user computer 102, 102a to at least one other user computer 103 to enable the at least one other user 104, 105 to contribute to or complete the financial transaction wherein the at least one other user 104, 105 may split the financial transaction according to a percentage or amount or item with or without a tip amount associated with the financial transaction, or any combination thereof. In at least one embodiment of the invention, the system and method may accept a tip amount from the user computer or communication device 102, 102a to add to the financial transaction, accept a request of the invoice of the financial transaction from the user computer or communication device 102, 102a without interaction with a cashier merchant, sources of sales representative, or other entity accepting one or more payments, and accept and then digitally sign the financial transaction.

By way of one or more embodiments of the invention, the system and method may include disabling the digital signing of the financial transaction associated with the user with the cryptographic digital certificate if the user computer is in an area where cryptography is illegal or otherwise not allowed, for example as a result of export restrictions associated with digital cryptographic software.

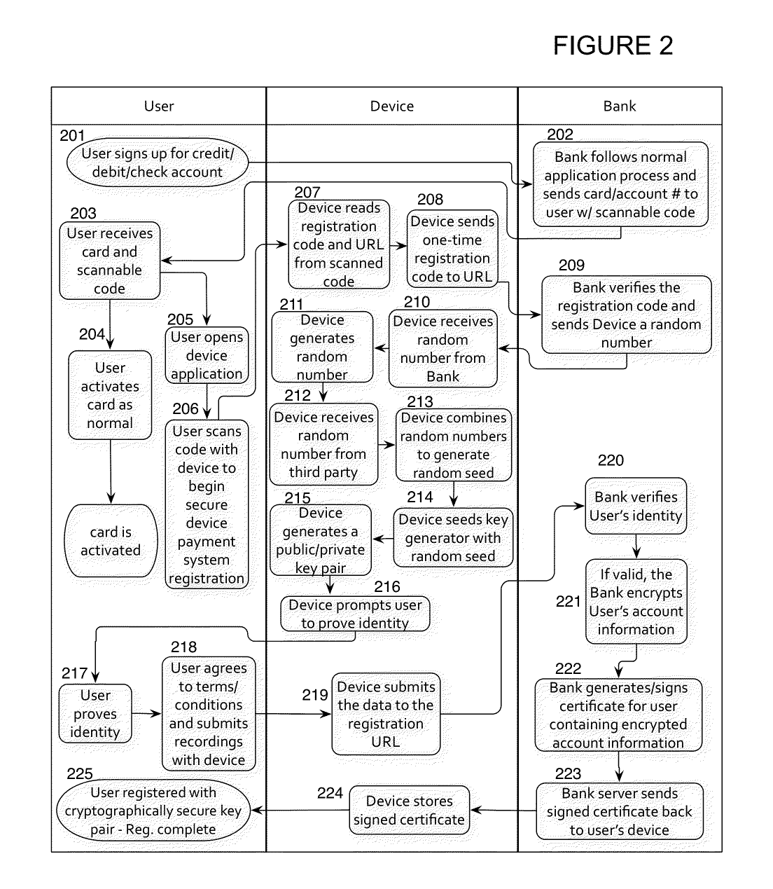

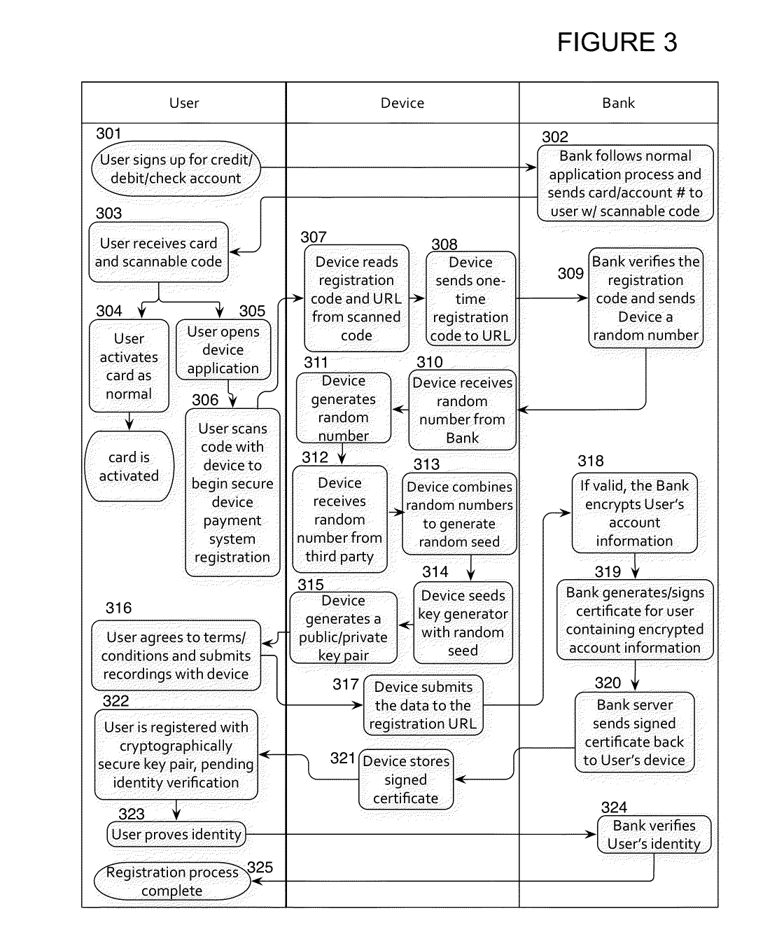

FIGS. 2-3 illustrate a first embodiment, and a second embodiment respectively, of the registration process according to an embodiment of the invention.

FIG. 2 shows a process of the user 101 signing up for a secure credit card, or any other financial instrument associated with an account as previously described, such that the process is backwards compatible with current registration processes, current financial account processes, and current financial account instruments, such as credit cards, debit cards, check books, money orders etc. As such, potential users may use the current registration processes, current financial account processes, and current financial account instruments and/or the anti-fraud financial system 100.

At 201, a user 101 signs up for a credit card, or any other financial account and/or financial account instrument as previously described, with a bank or any other financial institution. Although the term “bank” is utilized in the figures due to brevity, the term refers to any financial institution. This enables a user to request for a financial account and/or financial account instrument by online mechanisms, over the phone mechanisms, in person, or via mail.

At 202, the bank or any other financial institution follows its normal, or current, application processing methods and validates the user's request. If valid, the financial institution sends the financial account information and/or one or more financial instruments to the user along with a one-time use “scannable” code. The “scannable” code allows the user to scan the code using the user's one or more computers and/or one or more communication devices 102, 102a for secure payments and financial transaction processes. For example, embodiments of the system may include an application on mobile computer 102 having a QR Code or Quick Response Code scanner or other bar code reader, or code reader of any type. In at least one embodiment, the financial institution may transmit the financial account information and/or one or more financial instruments to the user by online mechanisms, over the phone mechanisms, in person, or via mail. Any other type of code that may be spoken, typed, scanned, or in any other manner accepted by an embodiment of the system may be utilized and embodiments that utilize a scannable code are exemplary as one skilled in the art will recognize. Any other types of codes may be utilized with embodiments of the invention in keeping within the spirit of the invention.

At 203, the user 101 receives the financial account information and/or financial instruments using one or more of the receipt methods discussed above, such as by online mechanisms, over the phone mechanisms, in person, or via mail.

At 204, the user 101 activates the financial account and/or one or more financial instruments received using current and existing registration processes, for example by dialing a number from the phone on record at the financial institution and entering the numbers of the credit card and any other code into the touch keys of a phone, after which the financial instrument is activated as shown.

At 205, the user 101 may instantiate one or more applications on the at least one computer and/or at least one communication device 102, 102a if the user 101 desires to use the secure payment mechanisms according to embodiments of the invention, e.g., with the one or more computers and/or one or more communication devices 102, 102a.

At 206, the user 101 may scan the one time use “scannable” code using the one or more computers and/or one or more communication devices 102, 102a in order to begin a secure device payment system registration process.

At 207, the one or more computers and/or one or more communication devices 102, 102a reads information from the “scannable” code that may be used during the registration process, wherein the information includes a registration code and a registration URL associated with the registration code.

At 208, the one or more computers and/or one or more communication devices 102, 102a may transmit the scanned-in one time user “scannable” code to the scanned-in URL in order to initiate the registration process with the financial institution. The one time use registration code, unique to the user's 101 registration process, may be randomly generated and is sufficiently complex in order to be difficult to guess, replicate or replay, and expires after a reasonable amount of time allowing the user to complete the registration process prior to the time of expiration.

At 209, the financial institution verifies the one time use registration code and, if verified as valid, transmits a random number back to the one or more computers and/or one or more communication devices 102, 102a.

At 210, the one or more computers and/or one or more communication devices 102, 102a, receive the random number generated from the financial institution, enabling the user 101 to continue with the registration process.

At 211, the one or more computers and/or one or more communication devices 102, 102a generates its own random number using a built-in random number generator, and/or a pseudorandom number generator.

At 212, the one or more computers and/or one or more communication devices 102, 102a receive a random number from a trusted third party, wherein the third party is preferably not associated with the financial institution. Any variation on the number of random numbers and/or pseudorandom numbers utilized in embodiments of the invention is in keeping with the spirit of the invention. Similarly, any variation on the order in which these numbers are received or generated in embodiments of the invention is in keeping with the spirit of the invention.

At 213, the one or more computers and/or one or more communication devices 102, 102a may combine the random numbers to generate a random seed. These random numbers may be combined by using any function, such as but not limited to an XOR function on all the random and pseudorandom numbers. In one or more embodiments, when using XOR, since XOR may preserve entropy, the resulting random seed may be randomly provided if at least one of the input numbers is random. In at least one embodiment, the one or more computers and/or one or more communication devices 102, 102a generate the random seed using three random numbers as inputs; however as one of ordinary skill in the art will appreciate, the one or more computers and/or one or more communication devices 102, 102a may generate a random number using zero or more random number inputs.

At 214, the one or more computers and/or one or more communication devices 102, 102a may seed the key generator with the random number seed.

At 215, the one or more computers and/or one or more communication devices 102, 102a may generate a cryptographically secure public/private key pair that is only known to the one or more computers and/or one or more communication devices 102, 102a in use, and which for example is not stored at the financial institution or on any other computer, e.g., as a shared key.

At 216, the one or more computers and/or one or more communication devices 102, 102a may prompt the user 101 to prove his/her identity, before the registration is complete. The one or more computers and/or one or more communication devices 102, 102a may provide the user 101 with one or more options on how to prove his/her identity. In one or more embodiments, these options may include trusted phone number authentication, allowing the user to capture video of the user speaking, writing or hand signing or otherwise outputting his/her public key and/or the hash value of his/her public key, using a network of already trusted users to vouch for this new user, snapping a photograph of the user potentially with evidence of the current date/time, audio recording, inputting personal details, etc. One or more embodiments may allow the user 101 to register, but impose restrictions (e.g. low credit limit, percentage dollar amount, a time span for using the financial account and/or financial instrument, etc.) until identification is proved.

At 217, the user 101 may prove his/her identity, by proving that he/she is the same individual who initially signed up for the financial account and/or financial instrument from the financial institution at 201, using one or more online mechanisms, over the phone mechanisms, in person, or via mail.

At 218, the user 101 may agree to the terms and conditions of the financial instrument or account, and/or the anti-fraud financial system provided by the one or more computers and/or one or more communication devices 102, 102a, in addition to optional other terms and conditions that may be enforced by the financial institution.

At 219, the one or more computers and/or one or more communication devices 102, 102a may submit data to the registration URL, for example after accepting inputs based on prompting the user at 216, such as submitting the identity proof, public key info, and other certificate information to the financial institution for further processing.

At 220, the financial institution website/server 110 may verify the user's 101 identity by looking at the proof provided by the user 101, depending on the type and method of identity proof the user 101 chooses to employ.

At 221, if the user's identity is found to be valid, the financial institution may encrypt any sensitive account information of the financial account or financial instrument, such as a card number, in a manner such that only the respective financial institution is able to decrypt it.

At 222, the financial institution may generate/create and sign a certificate for the user 101 that contains identifiable information about the user 101, the user's 101 public key information, and the encrypted account information. In one or more embodiments, the financial institution may then sign the certificate using the financial institution's own private key.

At 223, the financial institution server 110 may send the signed certificate to the user's one or more computers and/or one or more communication devices 102, 102a to allow the user 101 to store the certificate and public/private key pair using the user's one or more computers and/or one or more communication devices 102, 102a.

At 224, the one or more computers and/or one or more communication devices 102, 102a may store the signed certificate with the public/private key pair for future transactions. As such, at 225 the user is then registered with a cryptographically secure key pair, and the registration is complete. In one or more embodiment, only the user has access to his/her private key as opposed to shared keys, and hence the system is inherently secure.

FIG. 3 shows another process of the user 101 signing up for a secure credit card, or any other financial account as previously described, such that the process is backwards compatible with current registration processes, current financial account processes, and current financial account instruments, such as credit cards, debit cards, check books, money orders etc. As such, potential users may use the current registration processes, current financial account processes, and current financial account instruments and/or the anti-fraud financial system and method 100. FIG. 3 details an embodiment of the invention that differs from the embodiment detailed in FIG. 2 in that verification of the user's identity is completed after the user is registered with the cryptographically secure key pair instead of before.

At 301, a user 101 signs up for a credit card, or any other financial account and/or financial account instrument as previously described, with a bank or any other financial institution. Although the term “bank” is utilized in the figures due to brevity, the term refers to any financial institution. This enables a user to request a financial account and/or financial account instrument by online mechanisms, over the phone mechanisms, in person, or via mail.

At 302, the bank or any other financial institution follows its normal, or current, application processing methods and validates the user's request. If valid, the financial institution sends the financial account information and/or one or more financial instruments to the user along with a one-time use “scannable” code. The “scannable” code allows the user to scan the code using the user's one or more computers and/or one or more communication devices 102, 102a for secure payments and financial transaction processes. For example, embodiments of the system may include an application on mobile computer 102 having a QR Code or Quick Response Code scanner or other bar code reader, or code reader of any type. In at least one embodiment, the financial institution may transmit the financial account information and/or one or more financial instruments to the user by online mechanisms, over the phone mechanisms, in person, or via mail. Any other type of code that may be spoken, typed, scanned, or in any other manner accepted by an embodiment of the system may be utilized and embodiments that utilize a “scannable” code are exemplary as one skilled in the art will recognize. Other such codes keep within the spirit of the invention.

At 303, the user 101 receives the financial account information and/or financial instruments using one or more of the receipt methods discussed above, such as by online mechanisms, over the phone mechanisms, in person, or via mail.

At 304, the user 101 activates the financial account and/or one or more financial instruments received using current and existing registration processes, for example by dialing a number from the phone on record at the financial institution and entering the numbers of the credit card and any other code into the touch keys of a phone, after which the financial instrument is activated as shown.

At 305, the user 101 may instantiate one or more applications on the one or more computers and/or one or more communication devices 102, 102a if the user 101 desires to use the secure payment mechanisms with the one or more computers and/or one or more communication devices 102, 102a.

At 306, the user 101 may scan the one time use “scannable” code using the one or more computers and/or one or more communication devices 102, 102a in order to begin a secure device payment system registration process.

At 307, the one or more computers and/or one or more communication devices 102, 102a reads information from the “scannable” code that may be used during the registration process, wherein the information includes a registration code and a registration URL associated with the registration code.

At 308, the one or more computers and/or one or more communication devices 102, 102a may transmit the scanned-in one time user “scannable” code to the scanned-in URL in order to initiate the registration process with the financial institution. The one time use registration code, unique to the user's 101 registration process, may be randomly generated and is sufficiently complex in order to be difficult to guess, replicate or replay, and expires after a reasonable amount of time allowing the user to complete the registration process prior to the time of expiration.

At 309, the financial institution verifies the one time use registration code and, if verified as valid, transmits a random number back to the one or more computers and/or one or more communication devices 102, 102a.

At 310, the one or more computers and/or one or more communication devices 102, 102a receive the random number generated from the financial institution, enabling the user 101 to continue with the registration process.

At 311, the one or more computers and/or one or more communication devices 102, 102a generates its own random number using a built-in random number generator, and/or a pseudorandom number generator.

At 312, the one or more computers and/or one or more communication devices 102, 102a receive a random number from a trusted third party, wherein the third party is preferably not associated with the financial institution. Any variation on the number of random numbers and/or pseudorandom numbers utilized in embodiments of the invention is in keeping with the spirit of the invention. Similarly, any variation on the order in which these numbers are received or generated in embodiments of the invention is in keeping with the spirit of the invention.

At 313, the one or more computers and/or one or more communication devices 102, 102a may combine the random numbers to generate a random seed. These random numbers may be combined by using any function, such as but not limited to an XOR function on all the random and pseudorandom numbers. In one or more embodiments, when using XOR, since XOR may preserve entropy, the resulting random seed may be randomly provided if at least one of the input numbers is random. In at least one embodiment, the one or more computers and/or one or more communication devices 102, 102a generate the random seed using three random numbers as inputs; however as one of ordinary skill in the art will appreciate, the one or more computers and/or one or more communication devices 102, 102a may generate a random number using zero or more random number inputs.

At 314, the one or more computers and/or one or more communication devices 102, 102a may seed the key generator with the random number seed.

At 315, the one or more computers and/or one or more communication devices 102, 102a may generate a cryptographically secure public/private key pair that is only known to the one or more computers and/or one or more communication devices 102, 102a in use, and which for example is not stored at the financial institution or on any other computer, e.g., as a shared key.

At 316, the user 101 may agree to the terms and conditions of the financial instrument or account, and/or the anti-fraud financial system provided by the one or more computers and/or one or more communication devices 102, 102a, in addition to optional other terms and conditions that may be enforced by the financial institution.

At 317, the one or more computers and/or one or more communication devices 102, 102a may submit data to the registration URL, such as submitting public key info, and other certificate information to the financial institution for further processing.

At 318, the financial institution may verify the submitted data and information, and if valid, the financial institution may encrypt the user's financial account information and/or financial instrument information. In one or more embodiments, if valid, the financial institution may encrypt any sensitive account information of the financial account or financial instrument, such as a card number, in a manner that only the respective financial institution is able to decrypt it.

At 319, the financial institution may generate/create and sign a certificate for the user 101 that contains identifiable information about the user 101, the user's 101 public key information and the encrypted account information. In one or more embodiments, the financial institution, may then sign the certificate using the financial institution's own private key.

At 320, the financial institution server 110 may send the signed certificate to the user's one or more computers and/or one or more communication devices 102, 102a to allow the user 101 to store the certificate and public/private key pair using the user's one or more computers and/or one or more communication devices 102, 102a.

At 321, the one or more computers and/or one or more communication devices 102, 102a may store the signed certificate with the public/private key pair for future transactions, and the user 101 is then registered with a cryptographically secure key pair, pending the user's identify verification. In one or more embodiments, only the user has access to his/her private key as opposed to shared keys, and hence the system is inherently secure.

At 322, the one or more computers and/or one or more communication devices 102, 102a may prompt the user 101 to prove his/her identity at 323, before the verification and final registration is complete. The one or more computers and/or one or more communication devices 102, 102a may provide the user 101 with one or more options on how to prove his/her identity. In one or more embodiments, these option may include trusted phone number authentication, allowing the user to capture video of the user speaking, writing or hand signing or otherwise outputting his/her public key and/or the hash value of his/her public key, using a network of already trusted users to vouch for this new user, snapping a photograph of the user potentially with evidence of the current date/time, audio recording, inputting personal details, etc. Additionally or alternatively, the user may physically verify their identity at a brick-and-mortar branch of the financial institution or be verified by one or more Merchants during the user's one or more first and/or subsequent transactions with the secure device payment system. One or more embodiments may allow the user 101 to register, but may impose restrictions (e.g. low credit limit, percentage dollar amount, a time span for using the financial account and/or financial instrument, etc.) until identification is proved. The user 101 may prove his/her identity, by proving that he/she is the same individual who initially signed up for the financial account and/or financial instrument from the financial institution at 201, using one or more of online mechanisms, over the phone mechanisms, in person, or via mail.

At 324, the financial institution website/server 110 may verify the user's 101 identity by looking at the proof provided by the user 101, depending on the type and method of identity proof the user 101 chooses to employ.

At 325, the user's 101 registration is complete.

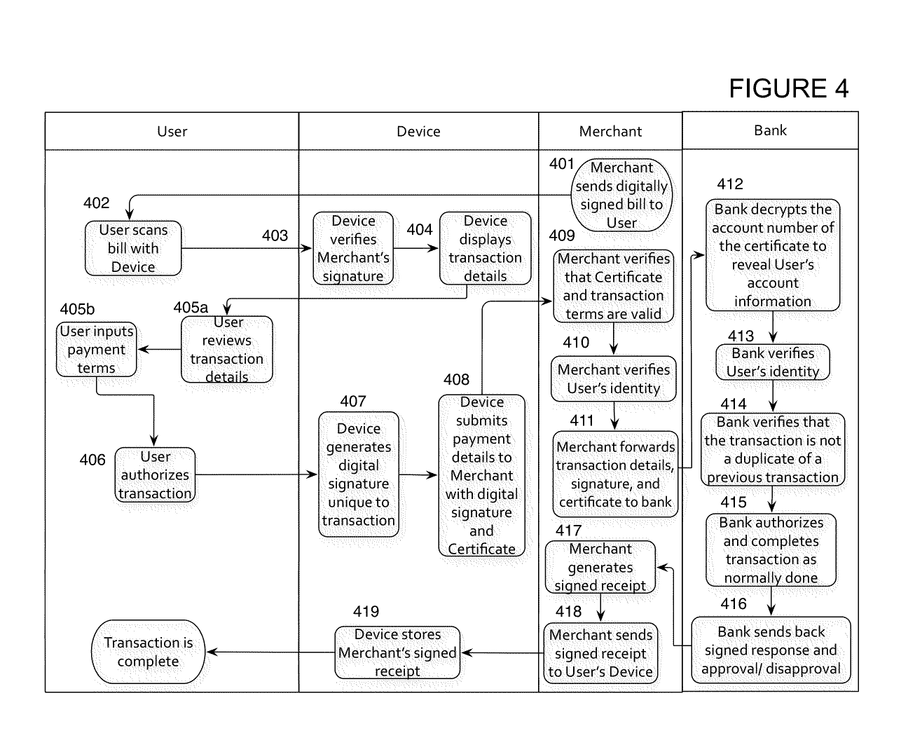

FIG. 4 illustrates an embodiment of the financial transaction process according to an embodiment of the invention. FIG. 4 shows an overall process of paying a bill, outstanding balance, statement, or charge in a secure and fraud resistant manner. In one or more embodiments of the system and method, the merchant may be a cashier, source of sales representative, or any other entity requesting payment. In addition, in one or more embodiments of the system and method, the bill may be one or more outstanding balances, one or more charges, and/or one or more statements. Furthermore, in one or more embodiments, the user may be one or more users and/or one or more customers.

At 401, the merchant transmits a digitally signed bill to the user 101. In at least one embodiment, the digitally signed bill is digitally signed to allow the user 101 to verify the merchant that is to be paid.

At 402, the user 101 scans the received bill with the one or more computers and/or one or more communication devices 102, 102a such that the received bill is received with the one or more computers and/or one or more communication devices 102, 102a. In one or more embodiments, scanning and receiving the bill may include scanning a barcode or QR code, applying optical character recognition (OCR) to a snapshot of the bill, typing in a code, downloading the bill via a network connection, or any other method of obtaining information associated with the bill and amount due, or any combination thereof. Any other type of code that may be spoken, typed, scanned, or in any other manner accepted by an embodiment of the system may be utilized and embodiments that utilize a “scannable” code are exemplary as one skilled in the art will recognize. Other such codes keep within the spirit of the invention.

At 403, the one or more computers and/or one or more communication devices 102, 102a may verify the merchant's digital signature after the user has scanned the bill, if present. In one or more embodiments, if the verification process of the digital signature fails, the user is automatically notified, and the process may be terminated.

At 404, if the digital signature is verified, the one or more computers and/or one or more communication devices 102, 102a may display one or more financial transaction details to the user 101. In one or more embodiments, the financial transaction details may include the merchant name, bill line items, total, date of sale, acceptable payment methods, etc., or any combination thereof.

At 405a, if the user 101 reviews the transaction details and/or if the user agrees to the financial transaction details displayed, the user 101 may select and input any payment terms desired at 405b, such as but not limited to selecting which financial account and/or financial instruments to use, which items, goods, or services listed on the financial transaction details to pay for, any gratuity to be added, what percentage of the bill to pay for as part of a group for example as previously described, or any combination thereof.

At 406, once the user 101 has selected and inputted the payment terms desired and agrees to the financial transaction details, the user may authorize the financial transaction via the one or more computers and/or one or more communication devices 102, 102a.

At 407, once the user 101 authorizes the financial transaction, the one or more computers and/or one or more communication devices 102, 102a being used may generate a digital signature that is unique to and only associated with the financial transaction being processed. In one or more embodiments, the generated digital signature provides proof that the owner of the private key, the user 101, has authorized the respective financial transaction.

At 408, once the digital signature has been generated, the one or more computers and/or one or more communication devices 102, 102a may submit the bill, financial transaction details, digital signature, and the user's certificate to the financial institution for further processing.

At 409, the merchant may verify that the certificate is valid and not expired, that the financial transaction details are valid, and verifies the digital signature of the transaction to determine that the user 101 has not altered any item, good or service, or price thereof, of the financial transaction and bill.

At 410, if the financial transaction is processed in person, or the merchant is able to process the financial transaction in person, the merchant may verify the identify of the user 101 who is attempting to process a payment for the financial transaction. In one or more embodiments, if the identity authentication is conducted in person, the merchant may ask for and check an identification card, a picture extracted from the certificate from the initial registration process, a video extracted from the initial registration process, etc., or any combination thereof. However, in one or more embodiments, if the verification of the user's identity is not possible, wherein the merchant does not current employ the necessary software, hardware, or technology of doing so, or if the merchant and/or the user are not physically present, this step is optional.

At 411, the merchant may forward the financial transaction information, including the bill, the user's financial transaction details, the user's signature and the user's certificate, to the processing financial institution.

At 412, the financial institution may extract the financial account information and/or financial instrument related information, such as a card number, expiration date, security code, full name, address, etc., or any combination thereof, by decrypting a serial number field of the certificate, or any other attribute of the user's certificate.

At 413, an optional step, the financial institution may verify the user's identify to ensure that the individual processing the financial transaction possesses the true identity, as opposed to a fraudulent user with a stolen device and/or private key. In one or more embodiments, this may be accomplished through various techniques, including, but not limited to, email verification, phone verification, challenge-response mechanism, PIN/password entry, etc., or any combination thereof. In at least one embodiment, at least the merchant or the bank verifies the user's identity at either 410 or 413. In other embodiments, both the merchant and the bank verify the user's identity at 410 and 413.

At 414, in order to protect against any replay attacks, the financial institution may check that the financial transaction is not a duplicate of a previous financial transaction. In one or more embodiment, since a digital signature is unique to an individual financial transaction, checking for true financial transactions may include checking the transaction number or a more in-depth check mechanism of other factors of the financial transaction, such as the digital signature.

At 415, the financial institution may process the financial transaction using current processing methods that exist since the financial institution has all of the details about the transaction necessary to complete the transaction as normally and currently done. As such, the system and method herein provides backwards compatibility with the current system for the financial institutions.

At 416, in order to provide non-repudiation of the financial institution's response, the financial institution sends a signed response to the merchant. In one or more embodiments, if the merchant is only using the current and existing financial system, then the financial institution may send the standard response as is currently done with exiting financial systems.

At 417, the merchant may generate a digitally signed receipt that may contain the digitally signed response from the financial institution. In one or more embodiments, the digitally signed receipt provides a much more secure receipt than the current system, since it cannot be forged.

At 418, the merchant may send the digitally signed receipt to the user.

At 419, the user's one or more computers and/or one or more communication devices 102, 102a may receive the signed receipt, may verify the signature, and may store the signed receipt. The transaction would then be complete. Optionally, in one or more embodiments, the one or more computers and/or one or more communication devices 102, 102a may send the receipt to another storage area as selected by the user, wherein the other storage area may be of another one or more users, of hardware components or software components, and may be remotely located from the user, or any combination thereof. Data may be transmitted over secure channels using SSL or TLS or any other secure communication protocol.

As one of ordinary skill in the art would appreciate, other processes are within the scope of the invention, including but not limited to the user receiving a signed approval of payment from the financial institution and forwarding the signed approval to the merchant, or the user sending a request for payment to the financial institution and the financial institution then communicating directly with the merchant.

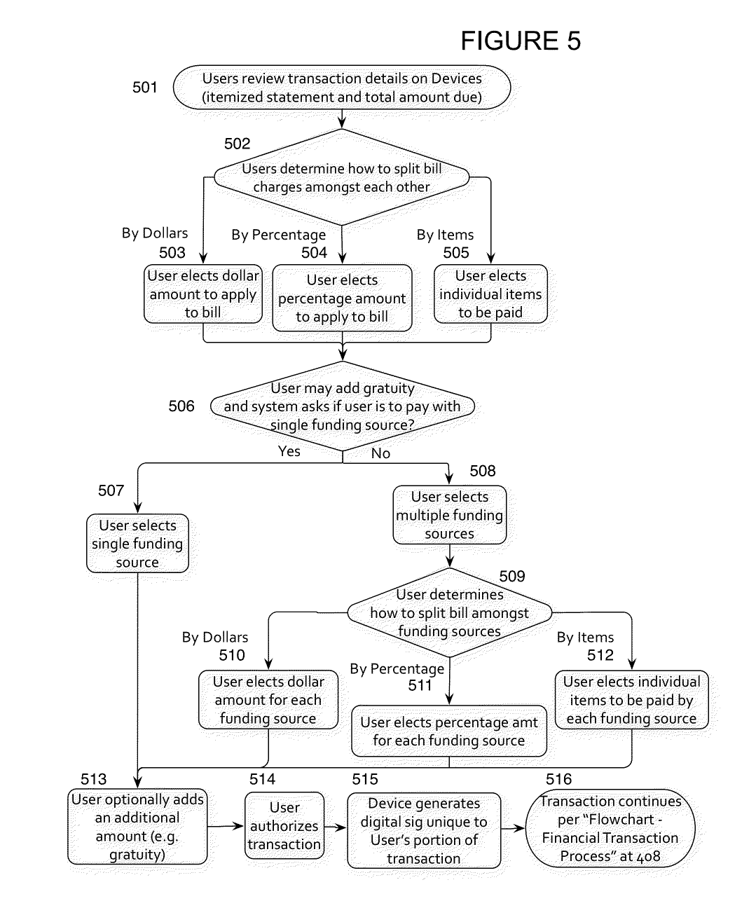

FIG. 5 illustrates an embodiment of the payment terms process according to an embodiment of the invention. FIG. 5 shows a process that includes a user 101, or one more additional users 104, 105, that may scan a bill into the one or more computers and/or one or more communication devices 102, 102a in order to process a payment. In one or more embodiments, the process of FIG. 5 allows the user 101 and/or one or more additional users 104, 105, to split the bill amongst the users and amongst their individual payment financial accounts and/or financial instruments (e.g. secure credit card, secure debit card, insecure credit card, cash, etc.) in a secure and fraud resistant manner. In at least one embodiment, the user 101 and the one or more additional users 104, 105 may mix different payment financial accounts and financial instruments, and thus, allow for backwards compatibility for users and financial accounts and/or financial instruments that do not have a secure payment device. In one or more embodiments of the system and method, the merchant may be a cashier, source of sales representative, or any other entity accepting any form of payment. In addition, in one or more embodiments of the system and method, the bill may be one or more outstanding balances, one or more charges, and/or one or more statements. Furthermore, in one or more embodiments, the user may be one or more users and/or one or more customers.

At 501, the user 101 and/or one or more additional users 104, 105 may each begin the process of paying a bill and scan in the bill on their respective one or more computers and/or one or more communication devices 102, 102a, 103, if the user 101 and/or one or more additional users 104, 105 have a secure payment device for secure payment device payment that allows one to scan the bill.

At 502, once the bill is scanned, the user 101 and/or one or more additional users 104, 105 may decide how to split the bill, or to not split the bill if one user is paying the entire bill. In one or more embodiments, splitting the bill may include, but is not limited to, splitting the bill by a nominal dollar amount, a percentage, and/or by individual line items. In one or more embodiments, the user 101 and/or one or more additional users 104, 105, may employ more than one of these methods that provides for very flexible splitting options.

At 503, the user 101 and/or one or more additional users 104, 105 may pay a fixed monetary amount of the bill.

At 504, user 101 and/or one or more additional users 104, 105 may pay a percentage of the entire bill, a percentage of one or more line items, or a percentage of the remaining amount.

At 505, user 101 and/or one or more additional users 104, 105 may select the individual line items of the bill that he/she wishes to pay for.

At 506, the user 101 may add gratuity and/or one or more additional users 104, 105 may add gratuity (or optionally at step 513) and the system provides the user and/or additional users with the option to pay via one or more funding sources, such as one or more financial accounts and/or one or more financial instruments.

At 507, the user 101 and/or one or more additional users 104, 105 selects to use a single funding source to pay for his/her portion of the bill.

At 508, the user 101 and/or one or more additional users 104, 105 may select to use more than one funding source, a plurality of funding sources, such as more than one financial account and/or more than one financial instrument.

At 509, each of the user 101 and/or one or more additional users 104, 105 determine how to split the bill amongst the select one or more funding sources, such that each of the user 101 and/or one or more additional users 104, 105 may split their portion of the bill amongst their individual one or more funding sources.

At 510, the user 101 and/or one or more additional users 104, 105 may elect to pay a fixed monetary amount of the bill with the one or more funding sources.

At 511, the user 101 and/or one or more additional users 104, 105 may elect to pay a percentage of the entire bill, a percentage of one or more line items, or a percentage of the remaining amount with the one or more funding sources.

At 512, the user 101 and/or one or more additional users 104, 105 may select the individual line items of the bill that he/she wishes to pay for with the one or more funding sources.

At 513, the user 101 and/or one or more additional users 104, 105 may add additional amounts of money to the total payment (e.g. to pay a tip). (Alternatively, this may be performed immediately as part of or before step 506 in one or more embodiments of the invention.)

At 514, once the user 101 and/or one or more additional users 104, 105 have made their respective elections and selections, the user 101 and/or one or more additional users 104, 105 may agree to the terms of the financial transaction and authorize and enable the respective one or more computers and/or one or more communication devices 102, 102a and 103, to process and apply the financial transaction.

At 515, the respective one or more computers and/or one or more communication devices 102, 102a and 103 may generate one or more digital signatures to authorize the financial transaction. In one or more embodiments, each of the respective one or more computers and/or one or more communication devices 102, 102a and 103 digital signatures may include the portion of the bill that he/she is paying for, ensuring that the merchant cannot get paid by multiple entities for the same bill items.

At 516, the specific transaction is complete, and continues per the financial transaction process flowchart discussed above, for example at step 408 of FIG. 4.

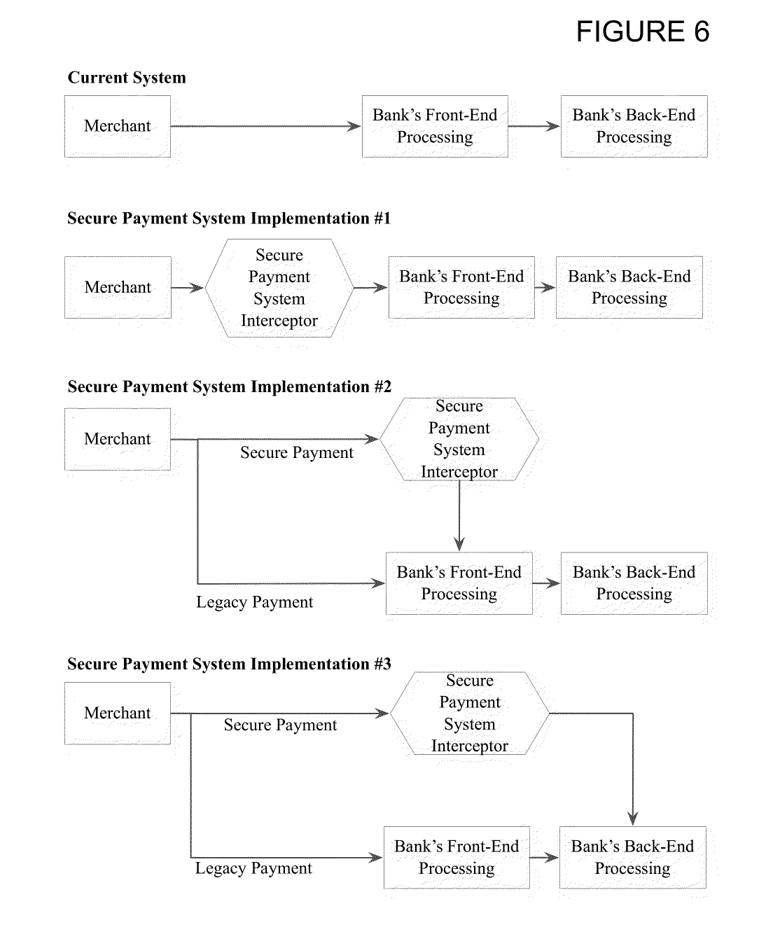

FIG. 6 illustrates an embodiment of the intercept process according to an embodiment of the invention. In one or more embodiments of the system and method, the merchant may be a cashier, source of sales representative, or any other entity accepting any form of payment. In addition, in one or more embodiments of the system and method, the bill may be one or more outstanding balances, one or more charges, and/or one or more statements. Furthermore, in one or more embodiments, the user may be one or more users and/or one or more customers.

As shown in FIG. 6, current existing financial systems include a merchant, a financial institution's front-end processing mechanisms, and the financial institution's back-end processing mechanisms.

According to one or more embodiments of the invention, a first secure payment system implementation includes a merchant, a secure payment system interceptor as discussed above, a financial institution's front-end processing mechanisms, and the financial institution's back-end processing mechanisms.

According to one or more embodiments of the invention, a second secure payment system implementation includes a merchant, a secure payment system through a secure payment system interceptor, and a legacy payment system through a financial institution's front-end processing mechanism. In at least one embodiment, the secure payment system interceptor communicates with the financial institution's front-end processing mechanism which then communicates with the financial institution's back-end processing mechanism.

According to one or more embodiments of the invention, a third secure payment system implementation includes a merchant, a secure payment system through a secure payment system interceptor, and a legacy payment system through a financial institution's front-end processing mechanism. In at least one embodiment, the secure payment system interceptor communicates with the financial institution's bank-end processing mechanism, and the financial institution's front-end processing mechanism is in communication with the financial institution's bank-end processing mechanism. Any other architecture capable of intercepting a digitally signed payment and converting the payment for use in a backward compatible manner with existing processing systems is in keeping with the spirit of the invention.

While the invention herein disclosed has been described by means of specific embodiments and applications thereof, numerous modifications and variations could be made thereto by those skilled in the art without departing from the scope of the invention set forth in the claims.

1. An anti-fraud financial method comprising:
registering a financial payment instrument by
generating a public key and private key and storing the public key and private key locally on a user computer,
transmitting the public key to a Certificate Authority server and retaining the private key locally,
obtaining a signed cryptographic digital certificate from the Certificate Authority server to complete the registering of the financial payment instrument;
digitally signing a financial transaction associated with a user with the private key to initiate the financial transaction with the financial payment instrument, wherein said digitally signing a financial transaction is configured to provide authentication and obtain authorization from the user and enable authorization from a financial institution to complete the financial transaction from a financial institution computer; and,
inserting an account number associated with the financial payment instrument into the cryptographic digital certificate to enable backwards compatibility with existing financial transaction systems.

2. The anti-fraud financial method of claim 1 further comprising:
obtaining a one-time use registration code and registration URL associated with the financial payment instrument via the user computer;
transmitting the one-time use registration code to a registration computer at the registration URL;
receiving a first random number to use at least as part of a seed from the registration computer; and,
seeding a key generator with the seed before generating the public key and private key.

3. The anti-fraud financial method of claim 2 further comprising:
receiving a second random number from a random number generating computer; and,
performing a function to combine the first and second random numbers to create the seed.

4. The anti-fraud financial method of claim 2 further comprising:
receiving a second random number from the random number generating computer;
creating a first pseudorandom number on the user computer; and,
performing a function to combine the first and second random numbers and the first pseudorandom number to create the seed.

5. The anti-fraud financial method of claim 2 further comprising:
generating a hash value of the public key via the user computer;
prompting the user to say the hash value of the public key;
recording video or capturing at least one image or audio of the user saying the hash value of the public key;
accepting an agreement of terms of services from the user; and,
submitting the hash value and video or at least one image or audio of the user to the registration computer at the registration URL.

6. The anti-fraud financial method of claim 5 further comprising:
verifying that the hash value is equal to the user's read out of the hash value;
obtaining a trusted picture of the user from a trusted source; and,
verifying that the user in the video or at least one image matches the trusted picture of the user from the trusted source before generating the cryptographic digital certificate.

7. The anti-fraud financial method of claim 5 further comprising:
obtaining a picture of the user from the video or at least one image; and,
inserting the picture of the user into the cryptographic digital certificate.

8. (canceled)

9. The anti-fraud financial method of claim 1 further comprising:
encrypting the accounting number so that only the financial institution can decrypt it before the inserting of the account number into the cryptographic digital certificate.

10. The anti-fraud financial method of claim 1 further comprising:
obtaining the account number wherein the account number is associated with an existing credit card account, existing debit card account, existing checking account, existing money transfer account or any combination thereof.

11. The anti-fraud financial method of claim 1 further comprising:
accepting a bill from a merchant computer for the financial transaction and then performing the digitally signing of the financial transaction to create a digitally signed invoice via the user computer; and,
transmitting the cryptographic digital certificate and the digitally signed invoice from the user computer to the merchant computer or financial institution computer or both.

12. The anti-fraud financial method of claim 11 further comprising:
verifying the digitally signed invoice of the financial transaction; and,
verifying that the cryptographic digital certificate has not expired and is trusted by the Certificate Authority.

13. The anti-fraud financial method of claim 11 further comprising:
verifying that a picture extracted from the cryptographic digital certificate is the user.

14. The anti-fraud financial method of claim 11 further comprising:
extracting the account number from the cryptographic digital certificate via the financial institution computer and processing the financial transaction associated with the account number with the existing financial transaction systems.

15. The anti-fraud financial method of claim 14 further comprising:
decrypting the account number using a key that is only known by the financial institution.

16. The anti-fraud financial method of claim 14 further comprising:
transmitting the authorization to complete the financial transaction to the merchant computer from the financial institution computer if the user has sufficient credit or funds to conduct the financial transaction; and,
transmitting a receipt or digitally signed receipt to the merchant computer or user computer or both.

17. The anti-fraud financial method of claim 1 further comprising:
displaying an advertisement, coupon, or discount to the user.

18. The anti-fraud financial method of claim 1 further comprising:
accepting from the user a temporal limit or range, spending maximum, category of financial transaction, recurring time of payment, list of users who can charge to a tab, a tab closeout command, secure return request, or any combination thereof to limit the financial transaction.

19. The anti-fraud financial method of claim 1 further comprising:
displaying information associated with at least one previous financial transaction.

20. The anti-fraud financial method of claim 1 further comprising:
displaying information associated with at least one previous financial transaction that is associated with the account number but which is potentially fraudulent, that was not a transaction associated with the user, that was invalidly signed, that was unsigned, that was signed but unknown to the user computer, or that was not a result of the digitally signing of the financial transaction to audit an account having the account number associated with the financial institution computer.

21. The anti-fraud financial method of claim 11 further comprising:
forwarding the invoice or receipt obtained from a merchant computer from the user computer to at least one other user computer to enable the at least one other user to contribute to or complete the financial transaction wherein the at least one other user may split the financial transaction according to a percentage or amount or item with or without a tip amount associated with the financial transaction, or any combination thereof.

22. The anti-fraud financial method of claim 11 further comprising:
accepting a tip amount from the user computer to add to the financial transaction.

23. The anti-fraud financial method of claim 11 further comprising:
accepting a request of the invoice for the financial transaction from the user computer without interaction with a cashier and accepting and then performing the digitally signing of the financial transaction to complete the financial transaction.

24. The anti-fraud financial method of claim 1 further comprising:
disabling the digitally signing of the financial transaction associated with the user with the cryptographic digital certificate if the user computer is in an area where cryptography is illegal or otherwise not allowed.

25. An anti-fraud financial method comprising:
registering a financial payment instrument by
generating a public key and private key and storing the public key and private key locally on a user computer,
transmitting the public key to a Certificate Authority server and retaining the private key locally,
obtaining a signed cryptographic digital certificate from the Certificate Authority server to complete the registering of the financial payment instrument;
digitally signing a financial transaction associated with a user with the private key to initiate the financial transaction with the financial payment instrument, wherein said digitally signing a financial transaction is configured to provide authentication and obtain authorization from the user and enable authorization from a financial institution to complete the financial transaction from a financial institution computer;
inserting an account number associated with the financial payment instrument into the cryptographic digital certificate to enable backwards compatibility with existing financial transaction systems;
encrypting the accounting number so that only the financial institution can decrypt it before the inserting of the account number into the cryptographic digital certificate; and,
obtaining the account number wherein the account number is associated with an existing credit card account, existing debit card account, existing checking account, existing money transfer account or any combination thereof.
